(19) United States
(12) Patent Application Publication
(10) Pub. No.: US 2025/0142047 A1
(43) Pub. Date: May 1, 2025

(54) CAMERA TEST DEVICES

(71) Applicant: SAMSUNG ELECTRONICS CO., LTD., Suwon-si (KR)

(72) Inventors: Sara Lee, Suwon-si (KR); Seungwan Jeon, Suwon-si (KR); Junho Han, Suwon-si (KR); Byoungho Kong, Suwon-si (KR); Sungsu Kim, Suwon-si (KR); Kichrl Park, Suwon-si (KR); Yugyung Lee, Suwon-si (KR); Subin Han, Suwon-si (KR)

(21) Appl. No.: 18/914,804

(22) Filed: Oct. 14, 2024

(30) Foreign Application Priority Data
Oct. 30, 2023 (KR) 10-2023-0147063

(51) Int. Cl. H04N 17/00

(52) U.S. Cl. CPC H04N 17/002

(57) ABSTRACT

An operating method of a camera test device using a test chart includes an operation of receiving, from a camera module, image data generated by imaging the test chart and an operation of measuring a resolution by depth of the camera module from the image data, wherein the test chart is a three-dimensional (3D) chart including a first test pattern radiating from a vertex of the test chart, and the first test pattern is a pattern of an outer surface of the test chart in which white and black surfaces are arranged alternately.

### CROSS-REFERENCE TO RELATED APPLICATION

This application claims priority under 35 USC § 119 to Korean Patent Application No. 10-2023-0147063, filed on Oct. 30, 2023, in the Korean Intellectual Property Office, the disclosure of which is incorporated by reference herein in its entirety.

### BACKGROUND

In the case of testing camera performance (e.g. resolution) based on a two-dimensional (2D) test chart, the 2D test chart is fixed at a certain depth or angle with respect to a camera. Camera performance may be measured only within a limited range and it may be difficult to measure the camera performance for images at various depths. In addition, in terms of the physical characteristics of lenses, camera lenses may guarantee clarity only for subjects within a focal length. Therefore, if a slight focus adjustment error occurs while measuring the camera performance based on a 2D test chart, the accuracy of the camera performance measurement may drastically decrease or the entire camera performance test may fail.

### SUMMARY

Aspects of this disclosure relate to camera test devices for measuring and/or evaluating the performance (e.g., resolution) of an external camera module based on a three-dimensional (3D) test chart, and operating methods thereof.

Some implementations relate to a performance test device for a camera module based on a test chart, for example, to a camera test device for measuring the performance (e.g., resolution) of a digital camera or a digital camera module mounted on a mobile communication terminal, and associated camera performance test methods.

Some aspects of this disclosure provide a camera test device capable of measuring or evaluating camera performance at various depths by using a 3D test chart, and operating methods thereof.

Some aspects of this disclosure provide a camera test device capable of performing a stable test by reducing the possibility of failure of the camera performance test due to an influence of a depth of field (DOF) of a camera lens, and operating methods thereof.

The scope of this disclosure is not limited to the implementations and advantages mentioned above, and other implementations and advantages may be clearly understood by those skilled in the art from this disclosure.

According to some implementations, there is provided an operating method of a camera test device using a test chart including an operation of receiving image data generated by imaging the test chart from a camera module and an operation of measuring resolution by depth of the camera module from the image data, wherein the test chart is a three-dimensional (3D) chart including a first test pattern radiating from a vertex of the test chart, and the first test pattern is a pattern of an outer surface of the test chart in which first and second surfaces are arranged alternately.

According to some implementations, there is provided an operating method of a camera test device using a test panel including an operation of receiving image data generated by imaging the test panel from a camera module and an operation of measuring resolution by depth of the camera module in each field of the image data, wherein the test panel includes a plurality of three-dimensional (3D) test charts arranged in a preset field, the plurality of 3D test charts include a first test pattern radiating from a vertex of each of the plurality of 3D test charts, and the first test pattern is a pattern of an outer surface of each of the plurality of 3D test charts in which first and second surfaces are arranged alternately, wherein the plurality of 3D different charts include a support in the form of a polyhedron and a second test pattern in which at least two surfaces are apart from each other using the support, and the at least two surfaces of the second test pattern have an empty space having a preset size in a center of each surface.

According to some implementations, there is provided an electronic device including a three-dimensional (3D) test chart including a pattern for measuring resolution of a camera module, a communication module configured to receive image data generated by imaging the 3D test chart from the camera module, a control module configured to measure resolution of the camera module using the image data, and a memory configured to store commands executed when the control module operates, the image data, and measured resolution data, wherein the 3D test chart includes a 3D chart in a relief form or a 3D chart in a hollow relief form, and the 3D chart in a relief form includes a first test pattern for measuring continuous resolution for each depth and a second test pattern for measuring discontinuous resolution measurement for each depth.

### BRIEF DESCRIPTION OF THE DRAWINGS

Various implementations will be more clearly understood from the following detailed description taken in conjunction with the accompanying drawings in which:

FIG. 1A illustrates an example of a camera performance test according to some implementations;

FIG. 1B illustrates an example of a photographing result for a camera module according to some implementations;

FIG. 2 is a block diagram of a camera test device according to some implementations;

FIGS. 3A to 3E illustrate an example of a test chart according to some implementations;

FIGS. 4A to 4B illustrate an example of indexing a test chart according to some implementations;

FIG. 5 illustrates an example of a focusing marker according to some implementations;

FIG. 6A illustrates an example of a test panel according to some implementations;

FIG. 6B illustrates an enlarged view of a test panel according to some implementations;

FIG. 7 illustrates camera performance test results for each depth of a camera test device according to some implementations;

FIG. 8 is a diagram illustrating an operation of determining an effective area of a camera test device according to some implementations;

FIG. 9 is a flowchart illustrating an operating method of a camera test device according to some implementations;

FIG. 10 is a flowchart illustrating an operating method of a camera test device according to some implementations;

FIG. 11 illustrates an example of an analysis result of image data based on a test chart according to some implementations;

FIG. 12A illustrates an example of a camera performance test based on a two-dimensional test chart as a comparative example; and

FIG. 12B illustrates an example of a camera performance test based on a three-dimensional test chart according to some implementations.

### DETAILED DESCRIPTION

Hereinafter, examples are described in detail with reference to the accompanying drawings.

Specific structural or functional descriptions are provided for the purpose of describing the examples. Implementations according to this disclosure may be implemented in various forms and should not be construed to be limited to the specific examples described below.

For example, the examples described below may be modified variously. It is to be understood that the scope of this disclosure is not limited to a specific disclosed form, but includes all modifications, equivalents, and substitutions without departing from the scope and spirit of the disclosure.

It will be understood that, although the terms “first,” “second,” etc. may be used herein to describe various components, these components should not be limited by these terms. These terms are only used to distinguish one component from another. For example, a first component may be termed a second component, and a second component may similarly be termed a first component, without departing from the scope of this disclosure.

Some terminology used herein to describe examples is not intended to limit the scope of the disclosure. Singular expressions include plural expressions unless the context clearly indicates otherwise. It will be understood that the terms “comprise,” “comprising,” “include,” and/or “including,” when used herein, specify the presence of stated features, numbers, steps, operations, elements, components, and/or groups thereof but do not preclude the presence or addition of one or more other features, numbers, steps, operations, elements, components, and/or groups thereof.

In addition, functions or operations may be performed in an order different from the order described below. For example, two consecutive blocks may actually be performed substantially simultaneously, or the blocks may be performed in reverse depending on a function or operation involved.

In this specification, a defect level of a test image may be estimated as a defect level of an image sensor corresponding to the test image.

Hereinafter, examples are described in detail with reference to the attached drawings.

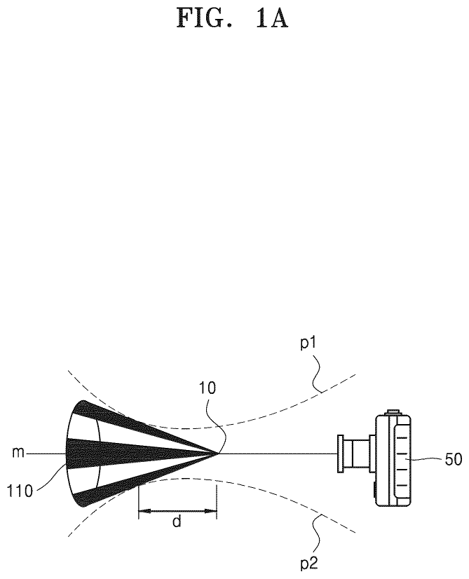

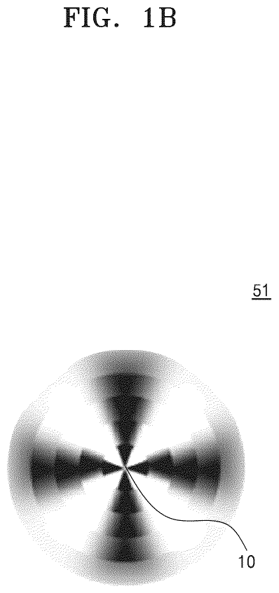

FIG. 1A illustrates an example of a camera performance test according to some implementations. FIG. 1A is a diagram illustrating an example of testing the performance (e.g., resolution) of a camera module 50 based on a test chart 110 according to some implementations. In FIG. 1A, it is assumed that a depth of field (DOF) of the camera module 50 is region ‘d’ according to a travel path (e.g., p1 and p2) of light, and the test chart 110 (for example, the vertex 10 of the test chart 110) is disposed on line ‘m’, which is an optical axis direction, i.e., a depth direction, of the camera module 50.

Referring to FIG. 1A, a camera test device (not shown) according to some implementations may receive image data generated by imaging the test chart 110 from the camera module 50 and measure resolution of the camera module 50 using the received image data, thereby performing a performance test of the camera module 50.

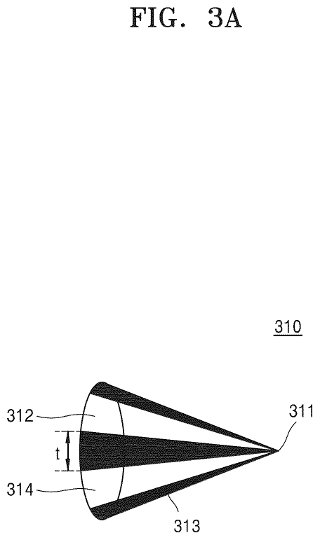

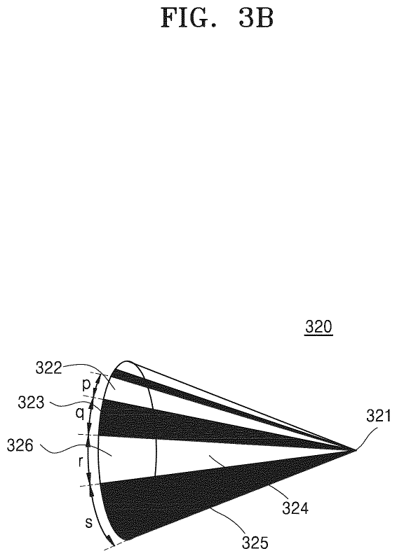

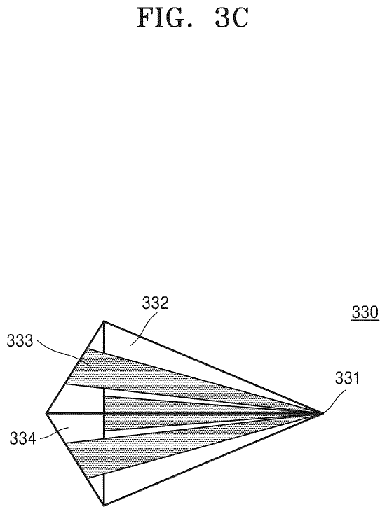

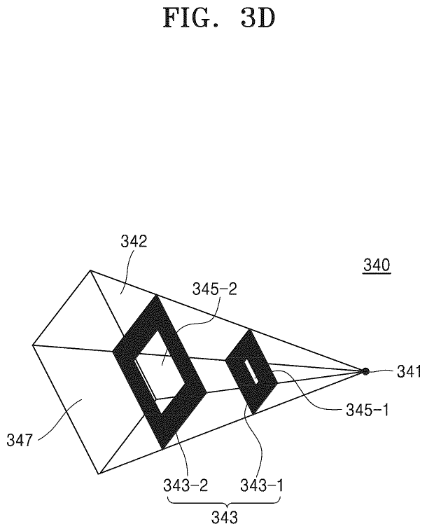

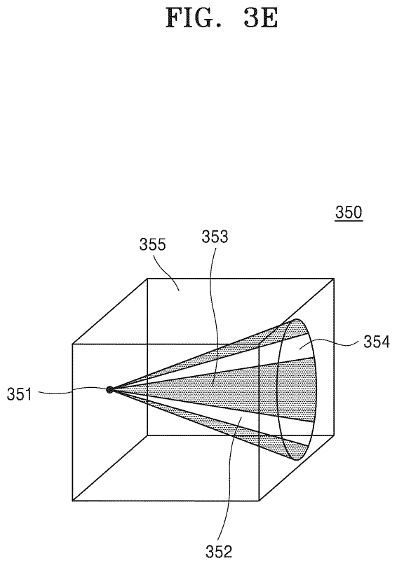

In some implementations, the test chart 110 may include a three-dimensional (3D) chart in a relief form or a 3D chart in a hollow relief form. The 3D chart in a relief form may include a conical 3D chart or a pyramid-shaped 3D chart, and the 3D chart in a relief form may include a first test pattern for measuring continuous resolution by depth and/or a second test pattern for measuring discontinuous resolution by depth. The 3D chart in a hollow relief form may include a 3D chart in which a cone shape or a polygonal pyramid shape is engraved inside a polyhedral box. For example, the test chart 110 of FIG. 1A is a 3D cone-shaped chart and includes the first test pattern for continuous resolution measurement by depth. A detailed description thereof is given below with reference to FIGS. 3A to 3E.

Accordingly, camera performance may be measured at various depths by performing camera performance measurement using a 3D test chart expanded in a depth direction. Some implementations of the camera test devices and operating methods discussed herein are capable of performing a stable test by minimizing the possibility of camera performance test failure due to a depth of field (DOF) of a lens of a camera module.

FIG. 1B illustrates an example of a camera imaging result according to some implementations. For example, the image data 51 of FIG. 1B can be generated by photographing the test chart 110 with the camera module 50 of FIG. 1A.

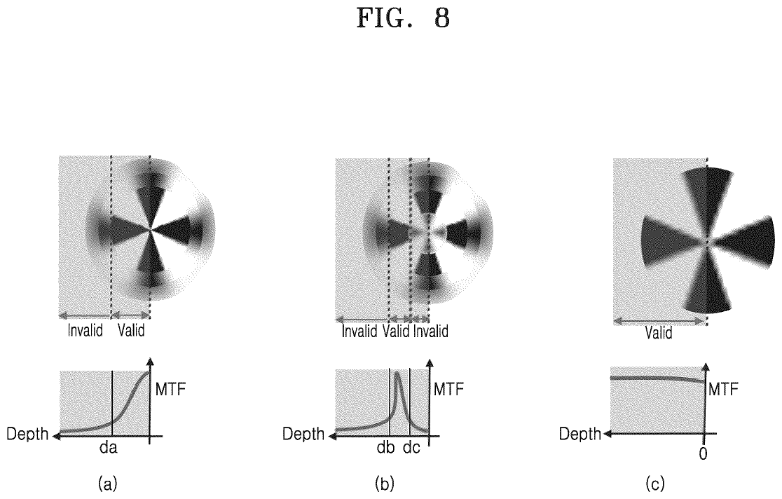

Referring to FIG. 1B, the image data 51 is data obtained by imaging a 3D cone-shaped test chart 110 expanded in the ‘m’ line direction, which is a depth direction, by the camera module 50, and may be in a form radiating from the vertex 10 of the test chart 110. A camera test device (for example, camera test device 100 discussed below) may measure performance (e.g., resolution) of the camera module 50 by depth based on the image data 51 to determine the progress of a change in performance by depth, based on which an effective area in the image data 51 may be determined according to the performance of the camera module 50 by depth. A description of the operation of determining the effective area within the image data 51 of the camera test device, according to some implementations, is provided below with reference to FIG. 8.

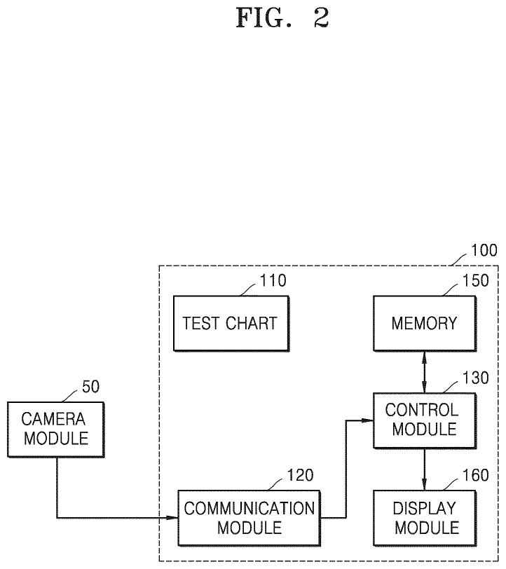

FIG. 2 is a block diagram of a camera test device 100 according to some implementations.

Referring to FIG. 2, the camera test device 100 according to some implementations may measure the performance (e.g., resolution) of the camera module 50 at various depths using the 3D test chart 110. The camera test device 100 may include the test chart 110 (which in some implementations is not included in the camera test device 100), a communication module 120, a control module 130, a memory 150, and a display module 160.

The test chart 110 provides a test pattern for measuring the performance of the camera module 50 as shown in FIG. 1A.

In some implementations, the test chart 110 may include a 3D chart in a relief form or a 3D chart in a hollow relief form. The 3D chart in a relief form may include a conical 3D chart or a pyramid-shaped 3D chart, and the 3D chart in a relief form may include a first test pattern for measuring continuous resolution by depth and/or a second test pattern for measuring discontinuous resolution by depth. For example, the first test pattern can be a pattern radiating from a vertex (e.g., vertex 10 in FIG. 1A) of the test chart 110, and, as a pattern of an outer surface of the test chart 110, a first surface (e.g. white) and a second surface (e.g. black) may be arranged alternately. The color of the first surface may be different from the color of the second surface. In the above description, although the first surface of the test chart 110 is described as white and the second surface is described as black, the scope of this disclosure is not limited thereto, and the color of the first surface of the test chart 110 and the color of the second surface according to some implementations may be a variety of different colors.

In some implementation's, the second test pattern includes a polyhedral support (e.g., a structure or framework for arranging test patterns to be apart from each other) and a pattern in which at least two black surfaces are apart from each other using the support. The at least two black surfaces may include an empty space having a preset size in the center of each surface.

The 3D chart in a hollow relief form may include a 3D chart in which a cone shape or a polygonal pyramid shape is engraved inside a polyhedral box. A detailed description of the test chart 110 is given below with reference to FIGS. 3A to 3E.

In some implementations, in the test chart 110, in order to ensure light uniformity when measuring the performance of the camera module 50, a portion of the test pattern may be configured as a light emitting body, or a bottom surface of the test chart 110 may be configured as a backlight. For example, in the 3D chart in a relief form, the first surface of the first test pattern may be configured as a light emitting body (or the outer surface of the first test pattern may be configured as a light emitting body), or the bottom surface of the test chart 110 may be configured as a backlight. For example, in the 3D chart in a hollow relief form, the first surface of the first test pattern may be configured as a light emitting body in a cone shape or a polygonal pyramid shape engraved inside the polyhedral box.

In some implementations, the test chart 110 may be installed on a line extending in a depth direction in front of the camera module 50 (e.g., the ‘m’ line in FIG. 1A). In that example, the depth direction refers to an optical axis direction of the lens in the camera module 50 in an ideal situation. In some implementations, the depth direction may include a direction perpendicular to a horizontal plane of the test chart 110 in consideration of errors.

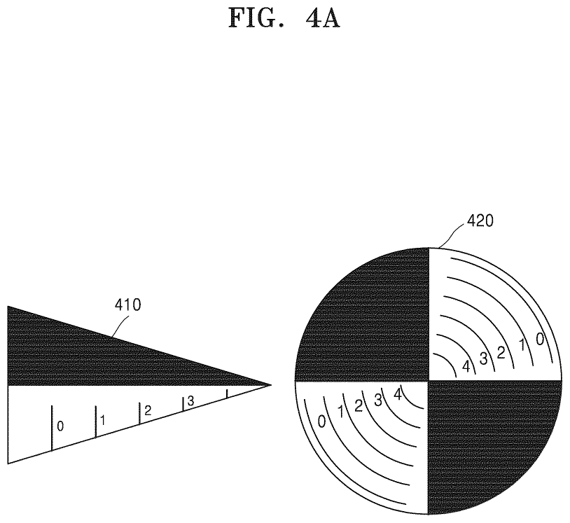

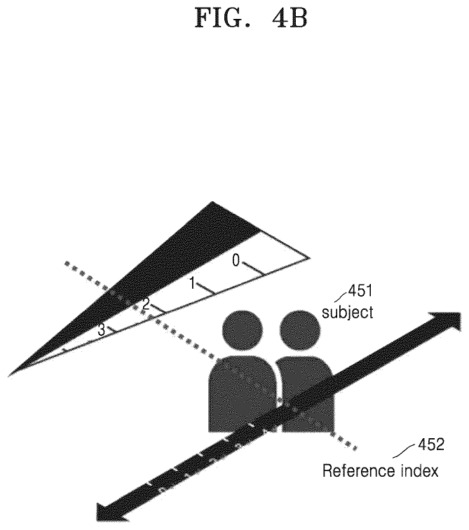

In some implementations, the test chart 110 may be configured such that an index for each depth is indicated on the outer surface of the test chart 110, or a reference index based on a subject is indicated on the test chart 110. A detailed description thereof is given below with reference to FIGS. 4A and 4B.

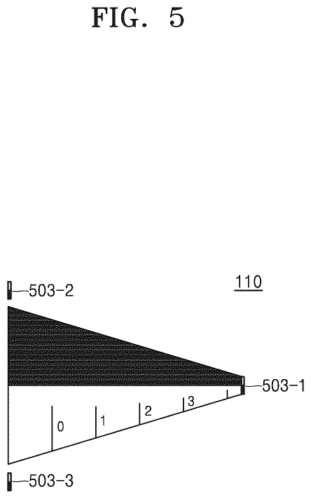

In some implementations, the test chart 110 may include a focusing marker for adjusting the focus of the camera module 50 and identifying whether the lens of the camera module 50 is distorted at the vertex of the test chart 110 and/or in a surrounding area of the test chart 110. A detailed description thereof is given below with reference to FIG. 5.

The communication module 120 may transmit and receive data to and from the camera module 50. For example, the communication module 120 may receive image data of the test chart 110 imaged by the camera module 50. In addition, the communication module 120 may transmit the received image data of the test chart 110 to the control module 130.

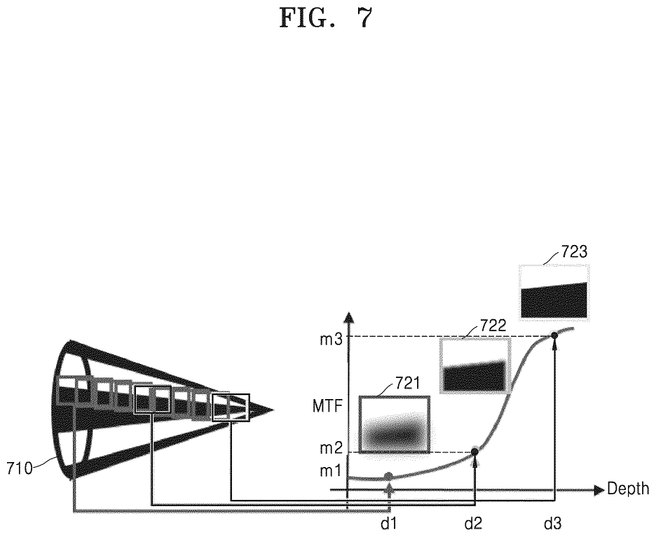

The control module 130 may analyze the obtained image data of the test chart 110 provided from the camera module 50 through the communication module 120 to measure (or inspect) performance (e.g., resolution by depth) of the camera module 50. For example, the control module 130 may determine an effective area within the image data using a modulation transfer function (MTF) value calculated by analyzing the image data. A detailed description thereof is given below with reference to FIGS. 7 and 8.

The control module 130 may store information on the performance (e.g., the MTF value, etc.) of the camera module 50 in the memory 150 and display the information associated with or indicating the measured performance (e.g., the MTF value, etc.) of the camera module 50 and/or the information on the effective area in the image data through the display module 160.

Camera test devices according to some implementations are configured to test camera performance for various depths, areas, and/or angles by testing camera performance based on a 3D test chart (or test panel including the same). Accordingly, in some cases, the possibility of failure of measurement of camera performance by a DOF of a camera lens may be reduced or eliminated.

FIGS. 3A to 3E illustrate examples of test charts according to some implementations.

FIG. 3A is a diagram illustrating a first test chart 310 as an example of the test chart 110 of FIG. 2.

Referring to FIG. 3A, the first test chart 310 is a 3D relief chart and is a cone-shaped test chart. The first test chart 310 may include a test pattern for measuring continuous resolution for each depth.

A test pattern of the first test chart 310 may be an isotropic pattern radiating from a vertex 311 of the first test chart 310. In addition, the test pattern is a pattern of an outer surface (e.g., a side surface of the cone) of the first test chart 310 in which a white fan-shaped surface (e.g. 312) and a black fan-shaped surface (e.g., 313) may be arranged alternately at equal intervals. For example, the test pattern of the first test chart 310 may be a pattern in which a white fan-shaped surface proportional to/covering an arc length ‘t’ and a black fan-shaped surface proportional to/covering the arc length ‘t’ are arranged alternately. Here, ‘t=(2π/N)’ and ‘N’ refers to the sum of the number of white fan-shaped surfaces plus the number of black fan-shaped surfaces.

In the first test chart 310, the white fan-shaped outer surface (e.g., 312) of the test pattern may be configured as a light emitting body or a bottom surface 314 of the first test chart 310 (e.g., opposite the vertex 311 in a depth direction) may be configured as a backlight.

The first test chart 310 may be configured such that a depth-specific index is marked on the side surface of the first test chart 310 (e.g., as described in reference to FIG. 4A) or a reference index based on the subject is marked on the first test chart 310. (e.g., as described in reference to FIG. 4B).

The first test chart 310 may include a focusing marker (e.g., as described in reference to FIG. 5) for adjusting the focus of the camera module 50 and identifying whether the lens of the camera module 50 is distorted at the vertex 311 of the first test chart 310 and/or in a surrounding area of the first test chart 310. In addition, or alternatively, the first test chart 310 may further include a cross pattern (e.g., as described in reference to FIG. 5) for horizontal adjustment of the camera module 50 in the surrounding area of the first test chart 310.

The first test chart 310 of FIG. 3A is described as including a white fan-shaped surface (e.g., 312) and a black fan-shaped surface (e.g., 313), but the colors are not limited thereto, and the first test chart 310 according to some implementations may include fan-shaped surfaces in various different colors.

The first test chart 310 of FIG. 3A, a 3D cone chart having a relief form, can be used in conjunction with, or in, the camera test devices described herein, and in the methods described herein, to continuously measure (or inspect) camera performance (e.g., resolution) at various depths.

FIG. 3B is a diagram illustrating a second test chart 320 as an example of the test chart 110 of FIG. 2.

Referring to FIG. 3B, the second test chart 320, like the first test chart 310 of FIG. 3A, may be a 3D cone test chart in a relief form and may include a test pattern for measuring continuous resolution by depth. A test pattern of the second test chart 320 may be an isotropic pattern radiating from a vertex 321 of the second test chart 320.

In the test pattern of the second test chart 320, white fan-shaped surfaces (e.g., 322 and 324) and black fan-shaped surfaces (e.g., 323 and 325), which are unevenly divided depending on the purpose/function of the test or user settings, may be arranged alternately. For example, the test pattern of the second test chart 320 may be a pattern in which the white fan-shaped surface 322 proportional/covering to an arc length ‘p’, the black fan-shaped surface 323 proportional/covering to an arc length ‘q’, the white fan-shaped surface 324 proportional to/covering an arc length ‘r’, and the black fan-shaped surface 325 proportional to/covering an arc length ‘s’ are arranged alternately. Here, the ‘p, q, r, and s’ may include preset values depending on the purpose/use of the camera test or the user's settings. Values of ‘p, q, r, and s’ can be wholly or partially different from one another.

In the second test chart 320, the white fan-shaped outer surface (e.g., 322 or 324) of the test pattern is configured as a light emitting body, or a bottom surface 326 of the second test chart 320 (e.g., opposite the vertex 321 in a depth direction) may be configured as a backlight.

The second test chart 320 may be configured such that an index for each depth is marked on a side surface of the second test chart 320 (e.g., as described in reference to FIG. 4A) or a reference index based on the subject is marked on the second test chart 320 (e.g., as described in reference to FIG. 4B).

The second test chart 320 may include a focusing marker (e.g., as described in reference to FIG. 5) for adjusting the focus of the camera module 50 and identifying whether the lens of the camera module 50 is distorted at the vertex 321 of the second test chart 320 and/or in a surrounding area of the second test chart 320. In addition, the second test chart 320 may further include a cross pattern (e.g., as described in reference to FIG. 5) for horizontal adjustment of the camera module 50 in the surrounding area of the second test chart 320.

The second test chart 320 of FIG. 3B is described as including the white fan-shaped surface (e.g., 322 and 324) and the black fan-shaped surface (e.g., 326), but is not limited thereto, and the second test chart 320 according to some implementations may include fan-shaped surfaces in various different colors.

The second test chart 320 of FIG. 3B, a 3D cone chart having a relief form, can be used in conjunction with, or in, the camera test devices described herein, and in the methods described herein, to continuously measure (or inspect) camera performance (e.g., resolution) at various depths.

FIG. 3C is a diagram illustrating a third test chart 330 as an example of the test chart 110 of FIG. 2.

Referring to FIG. 3C, the third test chart 330 is a 3D chart in a relief form and is a test chart in the form of a polygonal pyramid (e.g., triangular pyramid). The third test chart 330 may include a test pattern for measuring continuous resolution by depth.

The test pattern of the third test chart 330 may be an isotropic pattern radiating from a vertex 331 of the third test chart 330. In addition, the test pattern is a pattern of an outer surface (e.g., a side surface of the triangular pyramid) of the third test chart 330, in which a white triangular surface (e.g., 332) and a black triangular surface (e.g. 333) divided evenly or unevenly according to a preset area may be arranged alternately.

In the third test chart 330, the white triangular outer surface (e.g., 332) of the test pattern is configured as a light emitting body, or a bottom surface 334 of the third test chart 330 (e.g., opposite the vertex 331 in a depth direction) may be configured as a backlight.

The third test chart 330 may be configured such that an index for each depth is marked on a side surface of the third test chart 330 (e.g., as described in reference to FIG. 4A) or a reference index based on the subject is marked on the third test chart 330 (e.g., as described in reference to FIG. 4B).

The third test chart 330 may further include a focusing marker (e.g., as described in reference to FIG. 5) for adjusting the focus of the camera module 50 and identifying whether the lens of the camera module 50 is distorted at the vertex 331 of the third test chart 330 and/or in a surrounding area of the third test chart 330. In addition, the third test chart 330 may further include a cross pattern (e.g., as described in reference to FIG. 5) for horizontal adjustment of the camera module 50 in the surrounding area of the third test chart 330.

In FIG. 3C, for convenience of description, the third test chart 330 is shown in the form of a triangular pyramid. However, the shape is not limited thereto, and the camera test device according to some implementations may include a 3D test chart in various shapes of polygonal pyramids (e.g., quadrangular pyramids, pentagonal pyramids, and hexagonal pyramids).

The third test chart 330 of FIG. 3C is described as including the white triangular surface (e.g. 332) and the black triangular surface (e.g. 333), but the colors are not limited thereto and the third test chart 330 according to some implementations may include fan-shaped surfaces in various different colors.

The third test chart 330 of FIG. 3C, a polygonal pyramid chart having a relief form, can be used in conjunction with, or in, the camera test devices described herein, and in the methods described herein, to continuously measure (or inspect) camera performance (e.g., resolution) at various depths.

FIG. 3D is a diagram illustrating a fourth test chart 340 as an example of the test chart 110 of FIG. 2.

Referring to FIG. 3D, the fourth test chart 340 is a 3D chart in a relief form and is a test chart in the form of a polygonal pyramid (e.g., a quadrangular pyramid). The fourth test chart 340 may include a test pattern for measuring discontinuous resolution by depth. For example, the fourth test chart 340 may include a quadrangular pyramid-shaped support 342 and a test pattern 343 in which at least two surfaces (or at least two black surfaces) (e.g., a first surface 343-1 and a second surface 343-2) are spaced apart from each other (e.g., in a depth direction) using the support 342, and the at least two surfaces (e.g., the first surface 343-1 and the second surface 343-2) may include empty spaces having preset sizes (e.g., a first empty space 345-1 and a second empty space 345-2) in the interiors (e.g., centers) thereof, respectively. For example, a size of the second empty space 345-2 included in the second surface 343-2 of the fourth test chart 340 may be equal to or greater than an area of the first surface 343-1. The support 342 may include a structure or framework to separately locate the test pattern 343.

In the fourth test chart 340, a partial space (e.g., a space between the support 342 and the test pattern 343, etc.) inside the fourth test chart 340 may be configured as a light emitting body, or a bottom surface 347 of the support 342 of the fourth test chart 340 (e.g., opposite the vertex 341 in a depth direction) may be configured as a backlight.

The fourth test chart 340 may be configured such that an index for each depth is marked on a side surface of the fourth test chart 340 (e.g., as described in reference to FIG. 4A) or a reference index based on the subject is marked on the fourth test chart 340 (e.g., as described in reference to FIG. 4B).

The fourth test chart 340 may further include a focusing marker (e.g., as described in reference to FIG. 5) for adjusting the focus of the camera module 50 and identifying whether the lens of the camera module 50 is distorted at the vertex 341 of the fourth test chart 340 and/or in a surrounding area of the fourth test chart 340. In addition, the fourth test chart 340 may further include a cross pattern (e.g., as described in reference to FIG. 5) for horizontal adjustment of the camera module 50 in the surrounding area of the fourth test chart 340.

In FIG. 3D, for convenience of description, the fourth test chart 340 is shown as including the support 342 in the shape of a quadrangular pyramid, but the shape is not limited thereto, and the camera test device according to some implementations may include a discontinuous 3D test chart including the support 342 in the form of various polyhedrons.

The fourth test chart 340 of FIG. 3D, a 3D polygonal pyramid chart having a relief form, can be used in conjunction with, or in, the camera test devices described herein, and in the methods described herein, to discontinuously measure (or inspect) camera performance (e.g., resolution) at various depths.

FIG. 3E is a diagram illustrating a fifth test chart 350 as an example of the test chart 110 of FIG. 2.

Referring to FIG. 3E, the fifth test chart 350 is a 3D chart in a hollow relief form and includes a test chart in which a cone shape is engraved inside a polyhedral box 355. The fifth test chart 350 may include a test pattern for measuring continuous resolution for each depth. For example, the test pattern of the fifth test chart 350 may be an isotropic pattern radiating from a vertex 351 of the fifth test chart 350. The test pattern is a pattern of an engraved surface (e.g., a side surface of a cone) in the polyhedral box 355 of the fifth test chart 310, in which a white fan-shaped surface (e.g., 352) and a black fan-shaped surface (e.g., 353) divided evenly or unevenly according to a preset angle may be arranged alternately.

For example, the test pattern of the fifth test chart 350 may be a pattern in which the white fan-shaped surface (e.g. 352) proportional to/covering an arc length ‘v’ and the black fan-shaped surface (e.g. 353) proportional/covering to the arc length ‘v’ are arranged alternately at equal intervals, forming an even pattern. Here, ‘v=(2π/W)’ and ‘v’ refers to the arc length of the test pattern, and ‘W’ refers to the sum of the number of white fan-shaped surfaces (e.g. 352) plus the number of black fan-shaped surfaces (e.g. 353).

As another example, the test pattern of the fifth test chart 350 may be an uneven pattern in which a white fan-shaped surface proportional to/covering an arc length ‘e’, a black fan-shaped surface proportional to/covering an arc length ‘f’, a white fan-shaped surface proportional to/covering an arc length ‘g’, and a black fan-shaped surface proportional to/covering an arc length ‘h’ are arranged alternately, where ‘e’, ‘f’, ‘g’, and ‘h’ can be partially or wholly different from one another.

In the fifth test chart 350, the white fan-shaped surface (e.g., 352) of the test pattern may be configured as a light emitting body, or a bottom surface 354 (e.g., opposite the vertex 351) of the fifth test chart 350 may be configured as a backlight.

The fifth test chart 350 may be configured such that an index for each depth is marked on a side surface (a side surface of the cone) of the fifth test chart 350 or a reference index based on the subject is marked on the fifth test chart 350 (e.g., as described in reference to FIG. 4B).

The fifth test chart 350 may further include a focusing marker (e.g., as described in reference to FIG. 5) for adjusting the focus of the camera module 50 and identifying whether the lens of the camera module 50 is distorted at the vertex 351 of the fifth test chart 350 and/or in a surrounding area of the fifth test chart 350. In addition, the fifth test chart 350 may further include a cross pattern (e.g., as described in reference to FIG. 5) for horizontal adjustment of the camera module 50 in the surrounding area of the fifth test chart 350.

In FIG. 3E, for convenience of description, the fifth test chart 350 is shown with a cone-shaped 3D chart engraved in the polyhedral box 355, but the shape is not limited thereto, and the camera test device according to some implementations may include a 3D test chart in which various shapes of polygonal pyramids (e.g., triangular pyramids, quadrangular pyramids, pentagonal pyramids, hexagonal pyramids, etc.) are engraved.

The fifth test chart 350 of FIG. 3E is described as including the white fan-shaped surface (e.g., 352) and the black fan-shaped surface (e.g., 353) but the colors are not limited thereto, and the fifth test chart 350 according to some implementations may include fan-shaped surfaces in various different colors.

The fifth test chart 350 of FIG. 3E, a 3D cone chart or polycone chart having a relief form, can be used in conjunction with, or in, the camera test devices described herein, and in the methods described herein, to continuously measure (or inspect) camera performance (e.g., resolution) at various depths.

FIGS. 4A to 4B illustrate examples of indexing a test chart according to some implementations.

In FIG. 4A, the test chart (e.g., test chart 110) is a 3D chart in a relief form and is a cone-shaped test chart, and the test chart is assumed to include a test pattern for measuring continuous resolution for each depth.

Referring to FIG. 4A, a first drawing 410 and a second drawing 420 each illustrate one test chart viewed in different directions.

The first drawing 410 illustrates the test chart viewed in a direction parallel to a depth direction (e.g., a lateral direction of the first test chart 310 in FIG. 3A). Here, the depth direction may refer to an optical axis direction of the lens of the camera module 50. For example, in the first drawing 410, a depth index (e.g., 0, 1, 2, 3, . . . , etc.) and corresponding scales may be included in any one of the white fan-shaped surface or the black fan-shaped surface of the test pattern. Here, the depth index and the corresponding scales may be described in a color that contrasts with the color of the background fan-shaped surface.

The second drawing 420 illustrates the test chart viewed in a direction perpendicular to the depth direction (e.g., the direction of the vertex 311 of the first test chart 310 in FIG. 3A). Here, the depth direction may refer to an optical axis direction of the lens of the camera module 50. For example, in the second drawing 420, the depth index (e.g., 0, 1, 2, 3, . . . , etc.) and the corresponding scales may be arranged symmetrically on the while fan-shaped surface (or the black fan-shaped surface) to facilitate measurement.

For convenience of description, FIG. 4A is a 3D chart in a relief form and is described with the assumption that the test chart has a cone shape. However, the scope of this disclosure is not limited thereto, and the test chart according to some implementations may include indexing by depth in various types of 3D charts, such as a 3D polygonal pyramid chart in a relief form, a 3D chart in a hollow relief form, etc.

As shown in FIG. 4A, in some implementations, indexing by depth can be performed when measuring camera performance (e.g., resolution).

FIG. 4B illustrates an example of indexing based on a subject 451 according to some implementations.

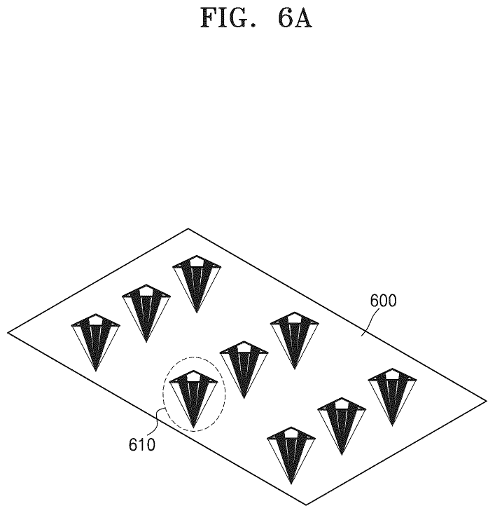

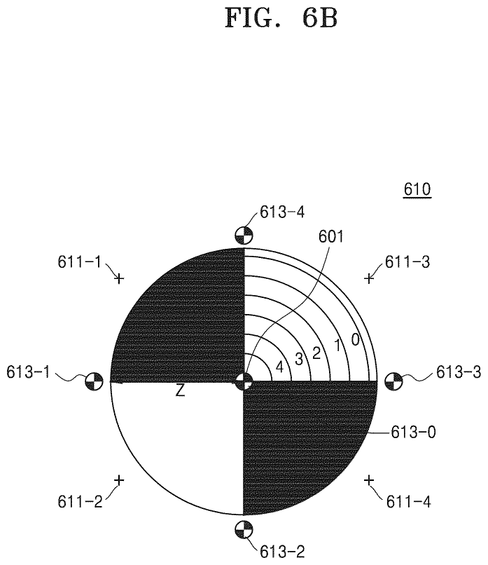

Referring to FIG. 4B, the subject 451 of a test chart (e.g., test chart 110) is shown to be located in the test chart or in a test panel 600 of FIG. 6A, which is described below. For example, the subject 451 may be located in a target area in which a test chart 610, which is a minimum unit chart in the test panel (600 in FIG. 6A), cross patterns (611-1 to 611-4 in FIG. 6B), and focusing markers (613-0 to 613-4 of FIG. 6B) are not arranged. The target area may include an area in which there is no distortion of the lens of the camera module 50 (e.g., an area within 0.5 fields of the image area).

In FIG. 4A, the index for each depth marked on the outer surface of the test chart 110 according to some implementations may provide a numerical value for quantitatively evaluating the depth in the image data. In FIG. 4B, an index based on the subject 451 according to some implementations may provide a reference index 452 to support the user's subjective determination of camera performance (e.g., resolution) of the camera test device 100. Accordingly, the user may perform a qualitative evaluation of camera performance (e.g., resolution) by depth based on the test chart and the reference index 452 marked thereon. For example, the reference index 452 may refer to a depth of a boundary point between the effective area and a non-effective area when the image data captured by the camera module 50 is observed with the naked eyes.

FIG. 5 illustrates an example of a focusing marker according to some implementations.

According to some implementations, when the camera module 50 measures camera performance (e.g., resolution) by imaging a 3D test chart 110 expanded in the depth direction, autofocusing of the camera module 50 at a target depth is used to measure a camera performance indicator (e.g., an MTF value) according to various depths of the test chart 110. A first focusing marker 503-1 to a third focusing marker 503-3 shown in FIG. 5 refer to markers for reducing or minimizing the effect due to autofocusing of the camera module 50 and/or lens distortion of the camera module 50 as described above.

Referring to FIG. 5, the test chart 110 may include at least one of the first focusing marker 503-1, the second focusing marker 503-2, or the third focusing marker 503-3. For example, the first focusing marker 503-1 may be located at the vertex (e.g., 311 in FIG. 3A) of the test chart 110, the second focusing marker 503-2 may be located at a position (+90°) rotated by 90° clockwise from the vertex of the test chart 110, and the third focusing marker 503-3 may be located at a position (−90°) rotated by 90° counterclockwise from the vertex of the test chart 110 (assuming the vertex of the test chart 110 as the origin).

In FIG. 5, for convenience of description, the three focusing markers are assumed to be the vertex and certain positions (e.g.,) (+90° position and) (−90° position) of the test chart 110, but are not limited thereto, and the test chart 110 according to some implementations may include a test chart in which various numbers of focusing markers are arranged at various positions.

FIG. 6A illustrates an example of the test panel 600 according to some implementations. The test panel 600 includes a plurality of test charts 610. The test chart 610 included in the test panel 600 of FIG. 6A is the minimum unit chart of the test panel 600 and may correspond to the test chart 110 described above with reference to FIGS. 1 to 5. For example, any of the test charts described with respect to FIGS. 1 to 5 can be used in plurality as test charts 610 in the test panel 600. In FIG. 6A, as a non-limiting example, the test chart 610 is a 3D chart in a relief form and with the shape of a triangular pyramid, and the test chart 610 includes a test pattern for measuring continuous resolution for each depth.

Referring to FIG. 6A, in some implementations, the test panel 600 may include the test charts 610 located in preset fields/areas (e.g., a central field, a peripheral field, and an outer field of the test panel 600) according to test purpose/use or user settings. For example, the test panel 600 may be configured to be divided into a total of nine fields at predetermined intervals, and each field includes one test chart 610.

In FIG. 6A, the test charts 610 of the test panel 600 are shown as being arranged in particular pattern according to test purpose/use or user settings, but the arrangement is not limited thereto, and the test charts 610 of the test panel 600 may be arranged irregularly in various positions within the test panel 600 other than preset, regular fields (e.g., the central field, peripheral field, and outer field of the test panel 600).

The test panel 600 may include the focusing marker or cross pattern of FIG. 5. A detailed description thereof is given below with reference to FIG. 6B.

For convenience of description, FIG. 6A is described based on the assumption that the test chart 610 in the shape of a triangular pyramid is the minimum unit chart of the test panel 600, but the test chart is not limited thereto, and the minimum unit chart of the test panel 600 according to some implementations may include various types of 3D charts, such as a 3D cone or polycone chart in a relief form, or a 3D chart in a hollow relief form.

Camera test devices and operating methods that include the test panel 600, according to some implementations, may have the technical effect of enabling performance evaluation by depth in each field based on the test panel including a plurality of 3D test charts.

FIG. 6B is an enlarged view of the test panel 600 according to some implementations. In detail, FIG. 6B illustrates an enlarged view of a test chart 610 included in the test panel 600, which is the minimum unit chart of FIG. 6A, and a surrounding area thereof. The test chart 610 corresponds to the test chart 110 described above with reference to FIGS. 1 to 6A, and the characteristics of the test chart 610 can be the characteristics described for the test chart 110 with reference to FIGS. I to 6A. In this example, the second focusing marker 613-1 to the fifth focusing marker 613-4 are located at a predetermined distance ‘Z’ from a vertex 601 of the test chart 610.

Referring to FIG. 6B, the test panel 600 may include a first cross pattern 611-1 to a fourth cross pattern 611-4 and a first focusing marker 613-0 to a fifth focusing marker 613-4 in the test chart 610 and/or a surrounding area thereof. Here, the cross patterns (e.g., the first cross pattern 611-1 to the fourth cross pattern 611-4) refer to patterns for adjusting a tilt of the camera module 50, and the focusing markers (e.g., the first focusing marker 613-0 to the fifth focusing marker 613-4) may refer to markers for focus adjustment (e.g., autofocusing) of the camera module 50 to measure a camera performance indicator (e.g., MTF value) according to various depths. In addition, the cross patterns and the focusing markers may be used to exclude lens distortion effects in the camera module 50. For example, the first cross pattern 611-1 may be located at a position rotated by 135° counterclockwise around the vertex 601 of the test chart 610, the second cross pattern 611-2 is located at a position rotated by 225° counterclockwise around the vertex 601 of the test chart 610, the third cross pattern 611-3 is located at a position rotated by 45° counterclockwise around the vertex 601 of the test chart 610, and the fourth cross pattern 611-4 may be located at a position rotated by 315° counterclockwise around the vertex 601 of the test chart 610 (for example, where the rotation is about the depth direction). For example, the first focusing marker 613-0 may be located at a position (e.g., origin) of the vertex 601 of the test chart 610, the second focusing marker 613-1 may be located at a position rotated by 180° counterclockwise around the vertex 601 of the test chart 610, the third focusing marker 613-2 may be located at a position rotated by 270° counterclockwise around the vertex 601 of the test chart 610, the fourth focusing marker 613-3 may be located at a position rotated by 0° counterclockwise around the vertex 601 of the test chart 610, and the fifth focusing marker 613-4 may be located at a position rotated by 90° counterclockwise around the vertex 601 of the test chart 610.

FIG. 7 illustrates camera performance test results for multiple depths of a camera test device according to some implementations. In detail, FIG. 7 is a diagram illustrating the results of a resolution test for each depth based on image data for a 3D test chart 710 captured by the camera module 50. The test chart 710 of FIG. 7 may correspond to the test chart 110 of FIGS. 1 to 6B described above. In FIG. 7, it is assumed that the horizontal axis of the graph on the right represents depth, and the vertical axis of the graph on the right represents an MTF value, which is an example of a camera performance indicator. It is assumed that a first depth d1 is not included within a DOF of the lens of the camera module 50, and a third depth d3 is included within the DOF of the lens of the camera module 50. An MTF value corresponding to the first depth d1 is ‘m1’, an MTF value corresponding to a second depth d2 is ‘m2’, and an MTF value corresponding to the third depth d3 is ‘m3’.

Referring to FIG. 7, the camera test device 100 (e.g., as shown in FIG. 2) according to some implementations may measure camera performance based on a 3D test chart 710 extended in the depth direction to measure a change in camera performance (e.g. resolution) continuous in the depth direction. For example, the camera test device 100 may determine a change in camera performance (e.g., resolution) according to a change in depth from the first depth d1 to the third depth d3. For example, as shown in FIG. 7, it can be confirmed that the third depth d3 is included in the DOF of the lens of the camera module 50, so partial image data 723 captured at the third depth d3 is relatively clear compared to partial image data 721 captured at the first depth d1, and the MTF value m3 corresponding to the third depth d3 is higher than the MTF value m1 corresponding to the first depth d1. It can be confirmed that partial image data 722 captured at the second depth d2 has medium clarity between the partial image data 721 captured at the first depth dl and the partial image data 723 captured at the third depth d3.

Therefore, the camera test device 100 and the operating methods thereof according to some implementations are capable of measuring (or evaluating) camera performance (e.g., resolution) that changes (e.g., continuously) depending on depth in image data.

FIG. 8 is a diagram illustrating an operation of determining an effective area of a camera test device according to some implementations.

In FIG. 8, the horizontal axis of the graphs (a), (b), and (c) represents depth, and the vertical axis of the graphs represents an MTF value, which is an example of a camera performance indicator. In example (a) of FIG. 8, the MTF value is equal to or greater than a threshold at a depth equal to or less than ‘da’, in (b) of FIG. 8, the MTF value is equal to or greater than the threshold at a depth greater than ‘dc’ and equal to or less than ‘db’, and in (c) of FIG. 8, the MTF value is equal to or greater than the threshold in a depth equal to or greater than ‘0’, that is, at all depths (for the graphs of (a), (b), and (c) of FIG. 8, the depth (or the depth direction) is deeper from the vertex of the test chart 110 toward the outer edge of the test chart 110).

In order to measure the performance (e.g., resolution) of the camera module 50, the camera test device 100 may calculate a resolution indicator (e.g., MTF) for each depth of the image data obtained by capturing the test chart 110 by the camera module 50 and identify whether the calculated resolution indicators by depth are equal to or greater than the threshold. Here, the threshold may be determined based on at least one of the type of image sensor of the camera module 50, a performance degradation value for each image sensor, a cognitive performance (e.g., resolution) degradation value, or a combination thereof.

When at least one of the resolution indicators for each depth of the image data is greater than or equal to the threshold, the camera test device 100 may determine a depth corresponding to the at least one resolution indicator as a valid area. When at least of the resolution indicators for each depth of the image data is less than the threshold, the camera test device 100 may determine the depth corresponding to the at least one resolution indicator as an invalid area.

Referring to example (a) of FIG. 8, in response to the MTF value being identified to be equal to or greater than the preset threshold in the depth equal to or less than ‘da’ in the image data, the camera test device 100 may determine the depth equal to or greater than ‘da’ in the image data as an effective area and the depth less than ‘da’ as a non-effective area.

Referring to example (b) of FIG. 8, in response to the MTF value being identified to be equal to or greater than the preset threshold in the depth equal to or greater than ‘de’ and less than ‘db’ in the image data, the camera test device 100 may determine the depth equal to or greater than ‘dc’ and less than ‘db’ as an effective area and the depth less than ‘de’ or exceeding ‘db’ as a non-effective area.

Referring to example (c), in response to the MTF value being identified to be equal to or greater than the preset threshold in the depth equal to or greater than the origin ‘0’ in the image data, the camera test device 100 may determine the entire depth equal to or greater than ‘0’ as an effective area in the image data.

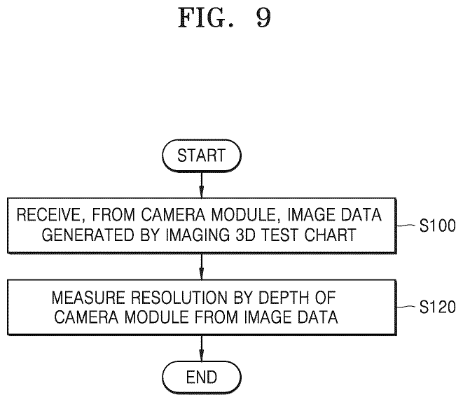

FIG. 9 is a flowchart illustrating an operating method of the camera test device 100 according to some implementations.

Referring to FIG. 9, a method of measuring (or inspecting) performance of the camera module (e.g., camera module 50) using a test chart (e.g., the test chart 110) of a camera test device (e.g., camera test device 100) may include operations S100 to S120. The test chart 110 of FIG. 9 may correspond to the test charts described above with reference to FIGS. 1 to 8.

In operation S100, the camera test device 100 may receive image data generated by imaging the 3D test chart 110 from the camera module. Here, the test chart 110 may include a 3D chart in a relief form or a 3D chart in a hollow relief form. The 3D chart in a relief form may include a conical 3D chart or a pyramid-shaped 3D chart, and the 3D chart in a relief form may include a first test pattern for measuring continuous resolution by depth and/or a second test pattern for measuring discontinuous resolution by depth. For example, the first test pattern may be a pattern radiating from the vertex (e.g., vertex 10 in FIG. 1A) of the test chart 110, and as a pattern of an outer surface of the test chart 110, a white surface and a black surface may be arranged alternately. For example, the second test pattern (e.g., 343 in FIG. 3D) may include a polyhedral support and a pattern in which at least two surfaces are apart from each other using the support, the at least two surfaces may include an empty space having a preset size in the center of each surface. In addition, the 3D chart (e.g., 350 in FIG. 3E) in a hollow relief form may include a 3D chart in which a cone shape or a polygonal pyramid shape is engraved inside a polyhedral box.

In some implementations, in the test chart 110, in order to ensure light uniformity when measuring the performance of the camera module 50, a portion (e.g., an outer surface of the test pattern) of the test pattern may be configured as a light emitting body, or a bottom surface of the test chart 110 may be configured as a backlight. For example, in the 3D chart in a relief form, the white surface of the first test pattern may be configured as a light emitting body, or the bottom surface of the test chart 110 may be configured as a backlight. For example, in the 3D chart in a hollow relief form, the first surface of the first test pattern may be configured as a light emitting body in either a cone shape or a polygonal pyramid shape engraved inside the polyhedral box.

In some implementations, the test chart 110 may be provided on a line extending in a depth direction in front of the camera module 50 (e.g., the ‘m’ line in FIG. 1A). In that example, the depth direction refers to an optical axis direction of the lens in the camera module 50 in an ideal situation. In some cases, the depth direction may include a direction perpendicular to a horizontal plane of the test chart 110 in consideration of errors.

In some implementations, the test chart 110 may be configured such that an index for each depth is indicated on the outer surface of the test chart 110 for quantitative evaluation of the performance of the camera module 50, and/or a reference index based on a subject is indicated on the test chart 110 for qualitative evaluation of the performance of the camera module 50.

In some implementations, the test chart 110 may include a focusing marker and/or a cross pattern for adjusting the focus of the camera module 50 at the vertex of the test chart 110 and/or in a surrounding area of the test chart 110.

In operation S120, the camera test device 100 may measure resolution for multiple depths of the camera module from the image data. In some implementations, the camera test device 100 may calculate resolution indicators for each depth of the image data. The resolution indicator for each depth may include an MTF value. The camera test device 100 may identify whether the resolution indicators for each depth satisfy a threshold condition (e.g., are greater than or equal to a threshold). For example, when at least one of the resolution indicators for each depth is greater than or equal to the threshold, the camera test device 100 may determine a depth corresponding to the at least one resolution indicator as an effective area. For example, when the at least one of the resolution indicators for each depth is less than the threshold, the camera test device 100 may determine the depth corresponding to the at least one resolution indicator as a non-effective area.

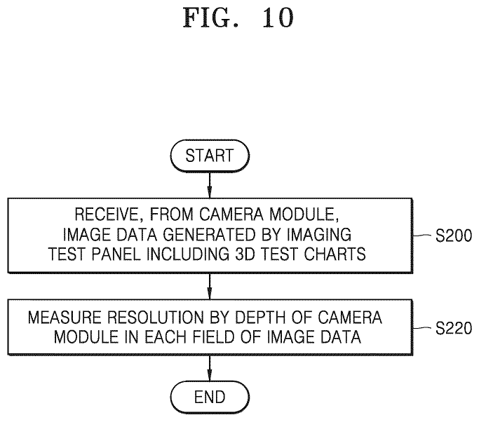

FIG. 10 is a flowchart illustrating an operating method of the camera test device 100 according to some implementations.

Referring to FIG. 10, a method of measuring (or inspecting) performance of a camera module (e.g., the camera module 50) using a test panel (e.g., test panel 600 in FIG. 6A) including multiple test charts (e.g., the test charts 110) may include operations S200 to S220. The test chart 110 of FIG. 10 may correspond to the test charts described above with reference to FIGS. 1 to 9. The method of measuring (or inspecting) performance of the camera module 50 in FIG. 10 is a method using a test panel including the test charts 110, and portions of the method of FIG. 10 that overlap the method of FIG. 9 can be performed as described with respect to FIG. 9.

In operation S200, the camera test device 100 may receive image data generated by imaging a test panel including the 3D test charts 110 from a camera module. The 3D test chart 110 may be the minimum unit chart of the test panel. In some implementations, the test panel may include test charts located in preset fields (e.g., areas) (e.g., a central field, a peripheral field, and an outer field of the test panel 600) according to test purpose/use or user settings. For example, the entire test panel may be divided into a total of nine fields (e.g., areas) at equal intervals, and each field may include one minimum unit chart (e.g., the 3D test chart 110).

In some implementations, the test panel may include a focusing marker for adjusting the focus of the camera module 50 and/or a cross pattern for horizontal adjustment of the camera module 50.

In operation S220, the camera test device 100 may measure depth-specific resolution of the camera module in multiple fields (e.g., each field) of the image data.

In some implementations, the camera test device 100 may calculate resolution indicators (e.g., MTF) for multiple depths in each measured field of the image data. The camera test device 100 may identify whether the resolution indicators for each depth satisfy a threshold condition (e.g., are greater than or equal to a threshold). For example, when at least one of the resolution indicators for each depth in each field of the image data is greater than or equal to the threshold, the camera test device 100 may determine the depth in the field corresponding to the at least one resolution indicator as an effective area. For example, when the at least one of the resolution indicators for each depth in each field of the image data is less than the threshold, the camera test device 100 may determine the depth in the field corresponding to the at least one resolution indicator as a non-effective area.

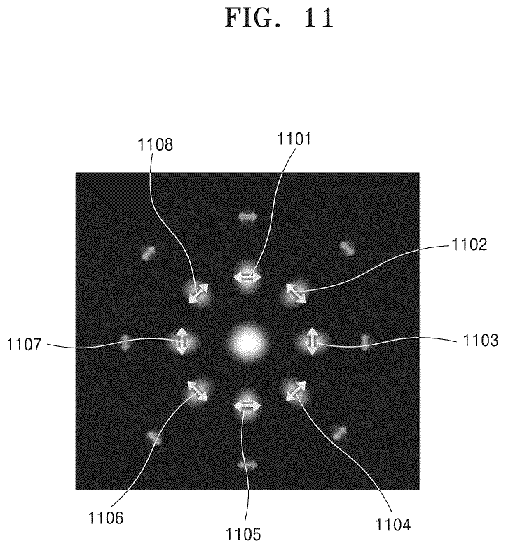

FIG. 11 illustrates an example of an analysis result of image data based on a test chart according to some implementations.

FIG. 11 is a result of analyzing image data for a test chart captured by the camera module 50 according to some implementations, and illustrates a calculation result of a point spread function (PSF) for each position of the test chart in the image data. The PSF may be calculated for an edge of the test chart, for example, at least one point on the border between a white surface and a black surface in the test pattern of the test chart. For FIG. 11, the test chart includes an isotropic 3D test chart (e.g., FIGS. 3A to 3C and 3E) of the test charts 110 of FIGS. 1 to 10.

Referring to FIG. 11, the calculation result of the PSF for each position may confirm that the PSF for points within the same radius from the origin (e.g., distance from the vertex of the test chart) has the same PSF width value as a single minimum PSF width. For example, it can be seen that the points (e.g., a first point 1101 to an eighth point 1108) within the same radius from the origin (e.g., the vertex of the test chart) all have the same PSF width value, and that the PSF width values are all obtained in a direction that minimizes lens distortion (or deterioration), so they all have the minimum PSF width value.

Accordingly, as provided by some implementations of this disclosure, since the performance (e.g., resolution) of the camera is measured using the test chart including an isotropic test pattern radiating from the center, the camera performance may be evaluated in a direction (e.g. an edge direction) that reduces or minimizes performance degradation of the camera (or an image sensor included in the camera) due to lens distortion in each direction. The obtained performance measurement results can be highly consistent with the performance of the actual camera (or the image sensor included in the camera).

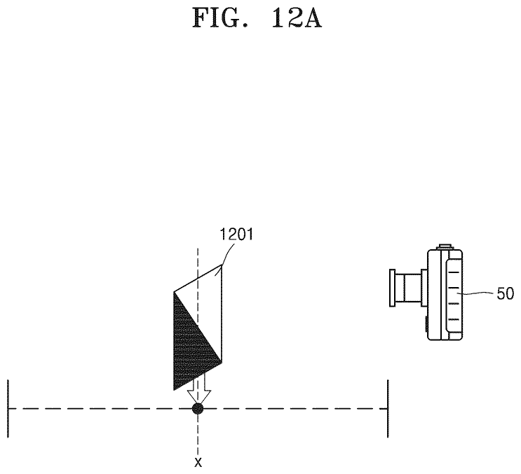

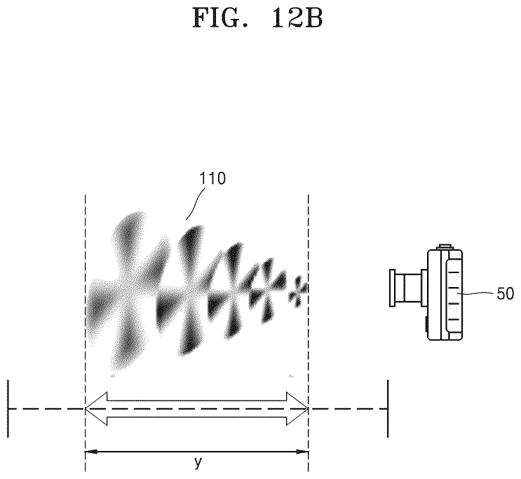

FIG. 12A illustrates an example of a camera performance test based on a 2D test chart, as a comparative example. FIG. 12B illustrates an example of a camera performance test based on a 3D test chart according to some implementations.

Referring to FIG. 12A, the camera test device according to the comparative example may measure (or inspect) camera performance based on image data generated by imaging the 2D test chart 1201 by the camera module 50.

In the camera test device according to the comparative example, it can be seen that a 2D test chart 1201 is located at a fixed angle at a certain depth ‘x’ so that the camera performance (e.g. resolution) may be measured only at a limited depth (e.g. depth ‘x’). In addition, the camera test device according to the comparative example may require precise focus adjustment of the lens to locate the 2D test chart 1201 within the DOF of the camera module 50. For example, when the 2D test chart 1201 according to the comparative example is not located within the DOF of the camera module 50 (e.g., when a slight error is included in the focus adjustment of the lens in the camera module 50), there is a possibility that the entire camera performance (e.g., resolution) test based on the 2D test chart 1201 may fail.

In contrast, referring to FIG. 12B, the camera test device (e.g., camera test device 100 of FIG. 2) according to some implementations may measure (or inspect) the camera performance based on the image data generated by imaging the 3D test chart 110. The test chart 110 of FIG. 12B may correspond to the test chart 110 of FIGS. 1 to 10 described above.

In the camera test device according to some implementations, the 3D test chart 110 is extended by ‘y’ in the depth direction, and thus, it is possible to measure continuous or discontinuous camera performance (e.g., resolution) within the extended depth range ‘y’. Here, the depth direction may refer to the optical axis direction of the camera module 50. In addition, in the camera test device according to some implementations, because the 3D test chart 110 extended by ‘y’ in the depth direction is used, the possibility of covering the DOF of the camera module 50 may increase, thereby reducing the possibility of failure throughout the camera performance test and improving the accuracy of test results.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While various examples have been particularly shown and described, it will be understood that various changes in form and details may be made therein without departing from the spirit and scope of the following claims.

What is claimed is:

1. A method comprising:
receiving, from a camera module, image data generated by imaging a test chart using the camera module; and
measuring, for multiple depths, a resolution of the camera module from the image data,
wherein the test chart comprises a three-dimensional (3D) chart including a first test pattern radiating from a vertex of the test chart, and
wherein the first test pattern is arranged on an outer surface of the test chart, the first test pattern comprising alternating first and second surfaces.

2. The method of claim 1, measuring the resolution for the multiple depths comprises:
calculating a resolution indicator for each depth of the multiple depths, and
identifying whether the resolution indicator for each depth satisfies a threshold condition.

3. The method of claim 2, wherein measuring the resolution for the multiple depths comprises at least one of:
in response to a first resolution indicator of the resolution indicators for the multiple depths satisfying the threshold condition, determining a depth corresponding to the first resolution indicator as an effective area; and
in response to a second resolution indicator of the resolution indicators for the multiple depths not satisfying the threshold condition, determining a depth corresponding to the second resolution indicator as a non-effective area.

4. The method of claim 1, wherein the test chart includes a focusing marker and a cross pattern, and wherein the method comprises:
using the focusing marker, (i) adjusting a focus of the camera module, (ii) identifying whether a lens of the camera module is distorted, or both (i) and (ii); and
performing a horizontal adjustment of the camera module using the cross pattern.

5. The method of claim 1, wherein the test chart includes a 3D chart in a relief form or a 3D chart in a hollow relief form,
wherein the 3D chart in the relief form includes a conical 3D chart or a pyramid-shaped 3D chart, and
wherein the 3D chart in the hollow relief form has a cone shape or a polygonal pyramid shape, the cone shape or the polygonal pyramid shape engraved inside a polyhedral box.

6. The method of claim 1, wherein the test chart includes a support in the form of a polyhedron and a second test pattern comprising at least two surfaces spaced apart from each other using the support, wherein the at least two surfaces have an empty space in an interior of each of the least two surfaces.

7. The method of claim 1, wherein the outer surface of the first test pattern is configured as a light emitting body.

8. The method of claim 1, wherein a bottom surface of the test chart is configured as a backlight.

9. The method of claim 1, wherein the test chart includes an index for a plurality of depths marked on the outer surface of the test chart.

10. The method of claim 1, wherein the test chart includes a reference index based on a subject.

11. An operating method comprising:
receiving, from a camera module, image data generated by imaging a test panel using the camera module; and
based on the image data, measuring, for multiple depths, a resolution of the camera module in each area of multiple areas of the test panel,
wherein the test panel includes a plurality of three-dimensional (3D) test charts arranged in corresponding areas of the multiple areas,
wherein the plurality of 3D test charts include first test patterns radiating from vertexes of each of the plurality of 3D test charts, and
wherein the first test patterns are arranged on outer surfaces of each of the plurality of 3D test charts, the first test patterns comprising alternating first and second surfaces.

12. The method of claim 11, wherein measuring the resolution for the multiple depths comprises:
calculating resolution indicators for each depth, of the multiple depths, in each area of the multiple areas, and
identifying whether the resolution indicators for each depth satisfies a threshold condition.

13. The method of claim 12, wherein measuring the resolution of the camera module for the multiple depths comprises at least one of:
in response to a first resolution indicator of the resolution indicators satisfying the threshold condition, determining a depth in an area corresponding to the first resolution indicator as an effective area; and
in response to a second resolution indicator of the resolution indicators not satisfying the threshold condition, determining a depth in an area corresponding to the second resolution indicator as a non-effective area.

14. The method of claim 11, wherein the test panel includes a focusing marker and a cross pattern, and wherein the method comprises:
using the focusing marker, (i) adjusting a focus of the camera module, (ii) identifying whether a lens of the camera module is distorted, or both (i) and (ii); and
performing a horizontal adjustment of the camera module using the cross pattern.

15. The method of claim 11, wherein the plurality of 3D test charts are configured as 3D charts in a relief form or 3D charts in a hollow relief form,
wherein the 3D charts in the relief form include a conical 3D chart or a pyramid-shaped 3D chart, and
wherein the 3D charts in the hollow relief form have a cone shape or a polygonal pyramid shape, the cone shape or the polygonal pyramid shape engraved inside a polyhedral box.

16. The method of claim 11, wherein the plurality of 3D test charts include:
a support in a form of a polyhedron, and
a second test pattern comprising at least two surfaces spaced apart from each other using the support, wherein the at least two surfaces have an empty space in an interior of each the at least two surfaces.

17. The method of claim 11, wherein, in the test panel, an outer surface of the first test patterns is configured as a light emitting body.

18. The method of claim 11, wherein, in the test panel, a bottom surface of each of the plurality of 3D test charts is configured as a backlight.

19. The operating method of claim 11, wherein, in the test panel, an index for a plurality of depths is marked on an outer surface of each of the plurality of 3D test charts, or a reference index based on a subject is marked on each of the plurality of 3D test charts.

20. An electronic device comprising:
a three-dimensional (3D) test chart including a pattern for measuring a resolution of a camera module;
a communication module configured to receive image data, from the camera module, generated by imaging the 3D test chart using the camera module;
a control module configured to measure the resolution of the camera module from the image data; and
a memory storing commands executable by the control module to measure the resolution, the image data, and measured resolution data,
wherein the 3D test chart includes a 3D chart in a relief form or a 3D chart in a hollow relief form, and
wherein the 3D chart in the relief form includes a first test pattern for measuring a continuous resolution for multiple depths and a second test pattern for measuring a discontinuous resolution for the multiple depths.
